(19) United States
(12) Patent Application Publication
(10) Pub. No.: US 2016/0152917 A1
(43) Pub. Date: Jun. 2, 2016

(54) LUBRICATING OIL ADDITIVE AND LUBRICATING OIL COMPOSITION

(71) Applicant: SHELL OIL COMPANY, Houston, TX (US)

(72) Inventors: Izumi KOBAYASHI, Tokyo (JP); Kiyoshi HANYUDA, Aikou, Kanagawa (JP); Yoshihiko AIHARA, Tokyo (JP)

(21) Appl. No.: 14/900,628

(22) PCT Filed: Jun. 27, 2014
(86) PCT No.: PCT/EP2014/063646

§ 371 Date: Dec. 22, 2015

(30) Foreign Application Priority Data
Jun. 28, 2013 (JP) 2013-137123

(51) Int. Cl. C10M 135/18; C07F 11/00; C10M 169/04; C10M 101/02; C10M 105/32

(52) U.S. Cl. CPC C10M 135/18; C10M 101/02; C10M 105/32; C10M 169/04; C07F 11/005

(57) ABSTRACT

A lubricating oil additive comprising an organic molybdenum compound represented by general formula (1) below: wherein in formula (1), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different. The lubricating oil additive is suitable for use as a friction modifier in a lubricating composition and is able to adjust frictional properties to a suitable level.

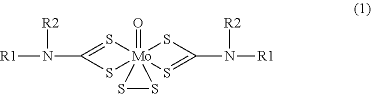

### FIELD OF THE INVENTION

The present invention relates to a lubricating oil additive and a lubricating oil composition. More specifically, the present invention relates to a lubricating oil additive able to adjust frictional properties to a suitable level, and a lubricating oil composition.

### BACKGROUND OF THE INVENTION

Lubricating oil additives used in order to adjust the frictional properties of a lubricant to a suitable level include friction modifiers. For example, friction modifiers having a friction-reducing effect are used in lubricating oil compositions such as gear oils and engine oils in order to achieve fuel savings. In addition, friction modifiers having a friction-improving effect are used in order to maintain a relatively high level of friction in lubricating oil compositions used in wet clutch components in automatic transmissions. Many types of these friction modifiers have been proposed.

In addition, organic molybdenum compounds are the most typical examples of such friction modifiers. In addition, as can be seen from New issue of “Petroleum Product Additives” edited by Toshio SAKURAI, published by Saiwai Shōbō on 25 Jul. 1986, these organic molybdenum compounds contain 2 molybdenum atoms per molecule, as shown in formulae (24) and (25) below.

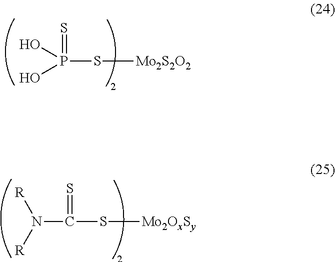

In addition, ‘Japanese Patent No. 3495764, Japanese Examined Patent Application Publication No. S45-24562, Japanese Unexamined Patent Application Publication No. S52-19629, Japanese Unexamined Patent Application Publication No. S52-106824 and Japanese Unexamined Patent Application Publication No. S48-56202 also disclose compounds that contain 2 molybdenum atoms per molecule. In addition, in cases where a compound that contains phosphorus in the molecule, as shown in the aforementioned formula (24), is added to an engine oil, the problem of catalyst poisoning occurs in exhaust gas purification devices, and compounds that contain no phosphorus are therefore required.

As a result, lubricating oil additives comprising compounds that contain no phosphorus have been proposed (for example, see Japanese Unexamined Patent Application Publication No. 2008-189561 and Japanese Unexamined Patent Application Publication No. 2008-189562).

In recent years, lubricating oil additives comprising compounds that contain no phosphorus, such as those disclosed in Japanese Unexamined Patent Application Publication No. 2008-189561 and Japanese Unexamined Patent Application Publication No. 2008-189562 have been proposed, but the number of such lubricating oil additives is still low, and development of novel lubricating oil additives is needed.

The present invention takes into account the above-mentioned problem. An objective of the present invention is to provide a lubricating oil additive able to be used as a friction modifier that adjusts the frictional properties of a lubricant and also to provide a lubricating oil composition that contains this type of lubricating oil additive.

### SUMMARY OF THE INVENTION

In order to solve the above-mentioned problem, the present invention provides the following lubricating oil additive and lubricating oil composition:

[1] A lubricating oil additive comprising an organic molybdenum compound represented by general formula (1) below:

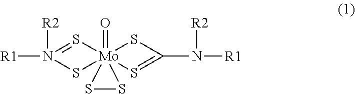

wherein in formula (1), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different); and
[2] A lubricating oil composition that contains the lubricating oil additive described in [1] above.

The lubricating oil additive of the present invention can be used as a molybdenum-based friction modifier that contains no phosphorus. In addition, the lubricating oil additive of the present invention exhibits a low coefficient of friction and can be advantageously used as an additive for a variety of energy-saving lubricating oils. Furthermore, by containing no phosphorus, the lubricating oil additive of the present invention is particularly suitable for use as a friction modifier for a fuel-saving engine oil.

The lubricating oil composition of the present invention can achieve an excellent friction-reducing effect and, as a result, an excellent fuel-saving effect.

### BRIEF DESCRIPTION OF THE DRAWINGS

FIG. 1 is a perspective diagram showing a schematic view of an SRV reciprocating-type friction tester used for friction tests.

### DETAILED DESCRIPTION OF THE INVENTION

Embodiments for carrying out the present invention will now be explained in detail. It should be noted that the present invention is not limited to the following embodiments, and that design alterations and improvements may be applied as appropriate on the basis of common technical knowledge of persons skilled in the art without deviating from the gist of the present invention.

### (1) Lubricating Oil Additive:

One embodiment of the lubricating oil additive of the present invention is a lubricating oil additive comprising an organic molybdenum compound represented by general formula (1) below.

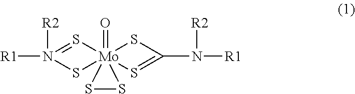

wherein in formula (1), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different).

In the alkyl group represented by the general formula CₙH₂ₙ₊₁ in R1, the number of carbon atoms (n) is preferably an integer from 2 to 20, more preferably an integer from 3 to 18, and most preferably an integer from 4 to 12. For example, examples of “alkyl groups having 2 to 20 carbon atoms” include ethyl groups, n-propyl groups, n-butyl groups, n-pentyl groups, n-hexyl groups, n-heptyl groups, n-octyl groups, n-nonyl groups, n-decyl groups, n-undecyl groups, n-dodecyl groups, n-tridecyl groups, n-tetradecyl groups, n-pentadecyl groups, n-hexadecyl groups, n-heptadecyl groups, n-octadecyl groups, n-nonadecyl groups, n-eicosyl groups, i-propyl groups, i-butyl groups, sec-butyl groups, t-butyl groups and t-dodecyl groups. However, R1 and R2 are different groups.

In addition, R1 in formula (1) may be a cyclohexyl group. An example of an organic molybdenum compound in which R1 is a cyclohexyl group and R2 is a methyl group is the compound represented by formula (2) below. In addition, an example of an organic molybdenum compound in which R1 is a cyclohexyl group and R2 is an ethyl group is the compound represented by formula (3) below. Lubricating oil additives comprising the organic molybdenum compounds represented by formulae (2) and (3) below can be used as molybdenum-based friction modifiers that contain no phosphorus. In addition, this type of lubricating oil additive exhibits a low coefficient of friction and can be advantageously used as an additive for a variety of energy-saving lubricating oils. By containing no phosphorus, the lubricating oil additive of the present embodiment is particularly suitable for use as a friction modifier for a fuel-saving engine oil.

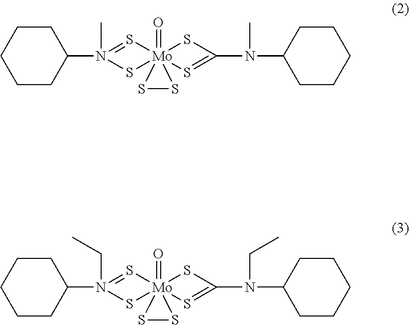

In addition, an example of an organic molybdenum compound in which R1 is an i-butyl group and R2 is a methyl group is the compound represented by formula (4) below. A lubricating oil additive comprising this type of organic molybdenum compound achieves a similar effect to a lubricating oil additive comprising the organic molybdenum compounds represented by formulae (2) and (3) above.

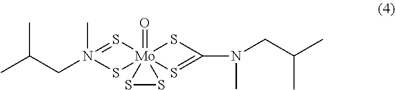

An example of an organic molybdenum compound in which R1 is an n-butyl group and R2 is a methyl group is the compound represented by formula (5) below. A lubricating oil additive comprising this type of organic molybdenum compound achieves a similar effect to a lubricating oil additive comprising the organic molybdenum compounds represented by formulae (2) to (4) above.

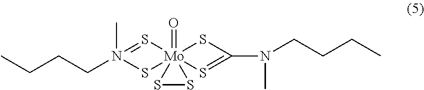

The organic molybdenum compound represented by general formula (1) above can be obtained by using, for example, the following method. A dithiocarbamate compound represented by general formula (6) below and sodium molybdate (Na₂MoO₄) are first dissolved in water. Next, dilute hydrochloric acid is added dropwise to this solution and then stirred for a period of, for example, 2 hours. After the stirring, the precipitate precipitated in the solution is filtered, washed with water, an alcohol, an ether and the like, and purified by being recrystallized from dichloromethane and n-hexane. In this way, it is possible to obtain an organic molybdenum compound represented by general formula (7) below. Triphenylphosphine and 1,2-dichloroethane are added to the obtained organic molybdenum compound represented by general formula (7) below and the resulting mixture is heated to reflux in an argon atmosphere. Propylene sulfide is then added to the mixture and heated to reflux in an argon atmosphere. The 1,2-dichloroethane is then distilled off under reduced pressure, thereby obtaining an organic molybdenum compound represented by general formula (1) above. The solid obtained by distilling off the 1,2-dichloroethane is then preferably purified by means of flash column chromatography using dichloromethane and n-hexane so as to obtain a high purity organic molybdenum compound represented by general formula (1) above.

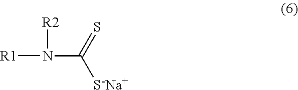

wherein in formula (6), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different.

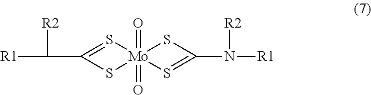

wherein in formula (7), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different.

Examples of the dithiocarbamate compound represented by general formula (6) above include compounds such as those represented by formulae (8) to (11) below. The compound represented by formula (8) below is sodium N-methyl cyclohexylamine dithiocarbamate. The compound represented by formula (9) below is sodium N-ethyl cyclohexylamine dithiocarbamate. The compound represented by formula (10) below is sodium N-methyl isobutylamine dithiocarbamate. The compound represented by formula (11) below is sodium N-methyl butylamine dithiocarbamate.

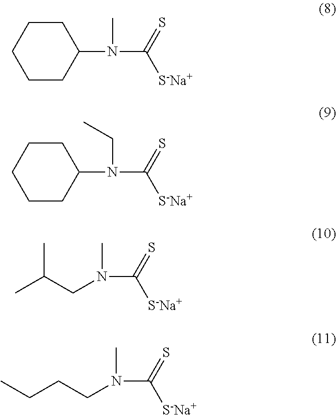

The sodium N-methyl cyclohexylamine dithiocarbamate represented by formula (8) above can be obtained as follows. First, an aqueous solution of sodium hydroxide and carbon disulfide are placed in a two-necked flask and, with the two-necked flask placed in an ice bath, N-methyl cyclohexylamine is added dropwise to the two-necked flask and stirred for a period of, for example, 1 hour and 30 minutes. After the stirring, the precipitate precipitated in the solution is filtered, washed with methylene chloride and diethyl ether and then washed with acetone, thereby producing the sodium N-methyl cyclohexylamine dithiocarbamate represented by formula (8) above. In addition, the sodium N-ethyl cyclohexylamine dithiocarbamate represented by formula (9) above can be obtained using the same method as that described above, except that N-ethyl cyclohexylamine is used instead of N-methyl cyclohexylamine. In addition, the sodium N-methyl isobutylamine dithiocarbamate represented by formula (10) above can be obtained using the same method as that described above, except that N-methyl isobutylamine is used instead of N-methyl cyclohexylamine. In addition, the sodium N-methyl butylamine dithiocarbamate represented by formula (11) above can be obtained using the same method as that described above, except that N-methyl butylamine is used instead of N-methyl cyclohexylamine.

### (2) Lubricating Oil Composition:

One embodiment of the lubricating oil composition of the present invention is a lubricating oil composition that contains a lubricating oil additive comprising an organic molybdenum compound represented by general formula (1) above (hereinafter referred to as “the present lubricating oil additive”). This type of lubricating oil composition can achieve an excellent friction-reducing effect and, as a result, an excellent fuel-saving effect.

Examples of the lubricating oil composition of the present embodiment include lubricating oils, greases and the like. The content of the present lubricating oil additive in the lubricating oil composition is not particularly limited. For example, the content of the present lubricating oil additive in the lubricating oil composition of the present embodiment is preferably 50 to 2000 ppm, more preferably 100 to 1500 ppm, and most preferably 200 to 1000 ppm, in terms of molybdenum. If this content is lower than 50 ppm, the generated quantity of a coating film of a molybdenum disulfide compound is reduced, meaning that the friction-reducing effect and fuel-saving effect are reduced, which is not desirable. If this content exceeds 2000 ppm, corrosion of non-ferrous metals occurs, which is not desirable. In addition, an excessively high content of the present lubricating oil additive leads to expensive molybdenum being used wastefully and is not desirable in terms of saving resources and reducing costs. Moreover, the quantity of molybdenum in the lubricating oil composition can be measured by carrying out elemental analysis using an inductively coupled plasma atomic emission spectrometer (hereinafter referred to as an “ICP method”).

In addition, the present lubricating oil additive may be contained at a proportion of, for example, 0.1 to 10 mass % relative to an ordinary composition. Here, ordinary composition means a conventional lubricating oil composition that does not contain the above-mentioned lubricating oil additive of the present embodiment.

The lubricating base oil used in the lubricating oil composition is not particularly limited, and may be a mineral oil or synthetic oil used in ordinary lubricating oils. Examples thereof include individual or mixed base oils belonging to Group 1, Group 2, Group 3, Group 4, Group 5 and so on in the base oil categories of the API (American Petroleum Institute).

If necessary, the lubricating oil composition of the present embodiment preferably contains at least one other type of additive selected from among the group comprising metal-based cleaning agents, ash-free dispersing agents, abrasion-preventing agents (zinc dialkyl dithiophosphates), corrosion inhibitors, metal-deactivating agents, antioxidants, viscosity index improving agents, pour point depressants and anti-foaming agents. Furthermore, the lubricating oil composition of the present embodiment may contain at least one other type of additive selected from among the group comprising demulsifiers, rubber swelling agents and friction modifiers. These other additives may be blended singly or as a mixture of a plurality of types.

### EXAMPLES

The present invention will now be explained in greater detail through the use of working examples, but is in no way limited to these working examples.

### Working Example 1

### Synthesis Example 1

### Synthesis of Intermediate Compound A

First, 50 cm³ of an aqueous solution of sodium hydroxide (12 g, 330 mmol) and carbon disulfide (5.3 cm³, 91 mmol) were placed in a 200 cm³ two-necked flask. Next, with the two-necked flask placed in an ice bath, N-methyl cyclohexylamine (10.2 g, 90.2 mmol) was added dropwise to the two-necked flask from a dropping funnel over a period of 30 minutes. The solution was then stirred for a period of 1 hour and 30 minutes using a mechanical stirrer. After the stirring, a white precipitate precipitated in the solution was subjected to suction filtration, washed with methylene chloride and diethyl ether and then washed thoroughly with acetone to give a compound. Hereinafter, the compound obtained in Synthesis Example 1 is referred to as intermediate compound A.

The obtained intermediate compound A was in the form of white crystals. In addition, the obtained quantity of intermediate compound A was 24.1 g, which was a yield of 12.6%. In addition, the obtained intermediate compound A was subjected to molecular weight measurement and elemental analysis. The obtained intermediate compound A had a molecular weight of 211.05 gmol⁻¹. In addition, the results of the elemental analysis are as follows.

Found1: C, 33.68%; H, 7.10%; N, 4.94%

Found2: C, 33.79%; H, 6.87%; N, 4.64%

Calcd.: C, 45.47%; H, 6.68%; N, 6.63%

From these results, it was understood that intermediate compound A obtained in Synthesis Example 1 was the compound represented by formula (8) above.

### Synthesis Example 2

### Synthesis of Organic Molybdenum Compound A1

Organic molybdenum compound A1 was synthesized using intermediate compound A obtained in Synthesis Example 1. Specifically, intermediate compound A (13.2 g, 115 mmol) and 13.0 g of sodium molybdate were first placed in a 500 cm³ two-necked flask, and dissolved in 100 cm³ of water. Next, 200 cm³ of dilute hydrochloric acid was added dropwise from a dropping funnel over a period of 30 minutes. The dilute hydrochloric acid was prepared by diluting 5.1 cm³ of concentrated hydrochloric acid. The solution was then stirred for a period of 2 hours using a mechanical stirrer. After the stirring, a precipitated brown precipitate was subjected to suction filtration, washed with water diethyl ether and methanol and then purified by being recrystallized from dichloromethane and n-hexane, thereby obtaining organic molybdenum compound A1.

The obtained organic molybdenum compound A1 was in the form of brown crystals. In addition, the obtained quantity of organic molybdenum compound A1 was 2.2 g, which was a yield of 14%. In addition, the obtained organic molybdenum compound A1 was subjected to molecular weight measurement and elemental analysis. The obtained organic molybdenum compound A1 had a molecular weight of 506.01 gmol⁻¹. In addition, the results of the elemental analysis are as follows.

Found1: C, 39.31%; H, 5.98%; N, 5.61%; S, 24.85%

Found2: C, 38.46%; H, 5.75%; N, 5.06%; S, 24.50%

Calcd.: C, 38.08%; H, 5.59%; N, 5.55%; S, 25.42%

From these results, it was understood that organic molybdenum compound A1 obtained in Synthesis Example 2 was the compound represented by formula (12) below. The reaction formula in Synthesis Example 2 is shown in formula (13) below.

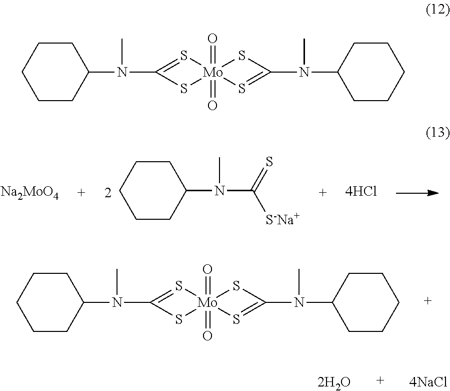

### Synthesis Example 3

### Synthesis of Organic Molybdenum Compound A2

Organic molybdenum compound A2 was synthesized using organic molybdenum compound A1 obtained in Synthesis Example 2. Specifically, organic molybdenum compound A1 (4.51 g, 8.91 mmol), 4.58 g of triphenylphosphine and 30 cm³ of 1,2-dichloroethane (distillation solvent) were first added to a 200 cm³ three-necked flask fitted with a reflux tube. Next, the three-necked flask was heated to reflux for 30 minutes in an argon atmosphere. 4.54 g of propylene sulfide was then added to the three-necked flask, and the resulting mixture was heated to reflux for 3 hours in an argon atmosphere. The 1,2-dichloroethane was then distilled off under reduced pressure, thereby obtaining a dark green solid. The obtained dark green solid was then purified by means of flash column chromatography using dichloromethane and n-hexane (at a ratio of 2:1 by volume), thereby obtaining organic molybdenum compound A2.

The obtained organic molybdenum compound A2 was in the form of dark green crystals. In addition, the obtained quantity of organic molybdenum compound A2 was 4.77 g, which was a yield of 92%. In addition, the obtained organic molybdenum compound A2 was subjected to molecular weight measurement and elemental analysis. The obtained organic molybdenum compound A2 had a molecular weight of 581.99 gmol⁻¹. In addition, the results of the elemental analysis are as follows.

Found1: C, 36.65%; H, 5.24%; N, 4.25%; S, 31.34%

Found2: C, 36.07%; H, 5.12%; N, 4.20%; S, 30.41%

Calcd.: C, 37.22%; H, 5.55%; N, 4.28%; S, 33.13%

From these results, it was understood that organic molybdenum compound A2 obtained in Synthesis Example 3 was the compound represented by formula (2) above. The reaction formula in Synthesis Example 3 is shown in formula (14) below. In formula (14) below, the complex “A1′” is a complex which is unstable to oxidation and which was obtained by adding triphenylphosphine and 1,2-dichloroethane (distillation solvent) to organic molybdenum compound A1 and heating to reflux in an argon atmosphere. Propylene sulfide was then added to the complex “A1′” and heated to reflux in an argon atmosphere, thereby obtaining organic molybdenum compound A2.

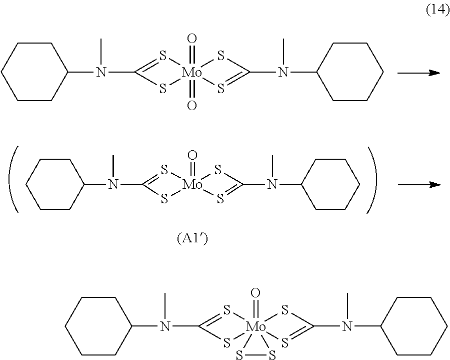

### Preparation of Lubricating Oil Composition of Working Example 1

The lubricating oil composition of Working Example 1 was prepared by adding organic molybdenum compound A2 obtained in Synthesis Example 3 to an ester oil so that the concentration of molybdenum derived from organic molybdenum compound A2 was 500 ppm, and stirring at 80° C. for 1 hour. The ester oil was diisononyl adipate. This ester oil had a kinematic viscosity at 100° C. of 3.04 mm²/s.

The obtained lubricating oil composition of Working Example 1 was subjected to a friction test using the following method.

### Friction Test

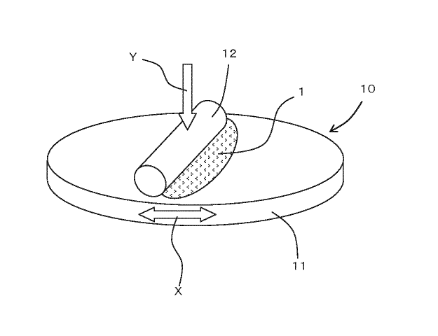

The coefficient of friction of the lubricating oil composition of Working Example 1 during reciprocating movement was measured using a SRV reciprocating-type friction tester. Here, FIG. 1 is a perspective diagram showing a schematic view of an SRV reciprocating-type friction tester used for friction tests. The SRV reciprocating-type friction tester (10) shown in FIG. 1 is a cylinder-on-disc-type reciprocating-type friction tester. The SRV reciprocating-type friction tester (10) is provided with a disc (11) for coating the lubricating oil composition (1) and a movable cylinder (12) able to be disposed in linear contact with the disc (11). The disc (11) is constituted so as to move reciprocally in the direction of the arrows indicated by the symbol X in FIG. 1. The cylinder (12) is constituted so as to be able to place a prescribed load on the disc (11) in the direction of the arrow indicated by the symbol Y in FIG. 1. The disc (11) and the cylinder (12) are constituted from 52100 steel.

In the friction test, the lubricating oil composition (1) was first coated on the disc (11) of the SRV reciprocating-type friction tester (10), as shown in FIG. 1. Next, the cylinder (12) was placed so as to be in linear contact with the disc (11), the disc (11) was moved reciprocally for a period of 30 minutes under the conditions described below, and the coefficient of friction during this process was measured. Friction test conditions: Load: 400 N, Frequency: 50 Hz, Amplitude: 1.5 mm, Temperature: 100° C. In addition, the coated quantity of the lubricating oil composition was 0.5 mm³. Table 1 shows the coefficient of friction at 500 seconds, 1000 seconds and 1500 seconds from the start of measurement.

TABLE 1

| | Coefficient of friction | | | | |
|---|---|---|---|---|---|
| | Work- | Work- | Work- | Work- | Compar- |
| Measurement | ing Ex- | ing Ex- | ing Ex- | ing Ex- | ative Ex- |
| period | ample 1 | ample 2 | ample 3 | ample 4 | ample 1 |
| 500 seconds | 0.067 | 0.063 | 0.086 | 0.093 | 0.180 |
| 1000 seconds | 0.078 | 0.072 | 0.095 | 0.097 | 0.185 |
| 1500 seconds | 0.096 | 0.093 | 0.095 | 0.097 | 0.181 |

### Working Example 2

### Synthesis Example 4

### Synthesis of Intermediate Compound B

First, 50 cm³ of an aqueous solution of sodium hydroxide (12 g, 330 mmol) and carbon disulfide (5.3 cm³, 91 mmol) were placed in a 200 cm³ two-necked flask. Next, with the two-necked flask placed in an ice bath, N-ethyl cyclohexylamine (10.1 g, 79.4 mmol) was added dropwise to the two-necked flask from a dropping funnel over a period of 30 minutes. The solution was then stirred for a period of 1 hour and 30 minutes using a mechanical stirrer. After the stirring, a white precipitate precipitated in the solution was subjected to suction filtration, washed with acetone and diethyl ether and then purified by being recrystallised from acetone to give a compound. Hereinafter, the compound obtained in Synthesis Example 4 is referred to as intermediate compound B.

The obtained intermediate compound B was in the form of white crystals. In addition, the obtained quantity of intermediate compound B was 10.6 g, which was a yield of 59%. In addition, the obtained intermediate compound B was subjected to molecular weight measurement and elemental analysis. The obtained intermediate compound B had a molecular weight of 225.06 gmol⁻¹. In addition, the results of the elemental analysis are as follows.

Found1: C, 34.79%; H, 7.52%; N, 4.46%

Found2: C, 35.45%; H, 7.24%; N, 4.53%

Calcd.: C, 47.97%; H, 7.16%; N, 6.22%

From these results, it was understood that intermediate compound B obtained in Synthesis Example 4 was the compound represented by formula (9) above.

### Synthesis Example 5

### Synthesis of Organic Molybdenum Compound B1

Organic molybdenum compound B1 was synthesized using intermediate compound B obtained in Synthesis Example 4. Specifically, intermediate compound B (6.02 g, 26.7 mmol) and 6.03 g of sodium molybdate were first placed in a 500 cm³ two-necked flask, and dissolved in 100 cm³ of water. Next, 200 cm³ of dilute hydrochloric acid was added dropwise from a dropping funnel over a period of 30 minutes. The dilute hydrochloric acid was prepared by diluting 5.1 cm³ of concentrated hydrochloric acid. The solution was then stirred for a period of 2 hours using a mechanical stirrer. After the stirring, a precipitated brown precipitate was subjected to suction filtration, washed with water diethyl ether and methanol and then purified by being recrystallized from dichloromethane and n-hexane, thereby obtaining organic molybdenum compound B1.

The obtained organic molybdenum compound B1 was in the form of ochre-coloured crystals. In addition, the obtained quantity of organic molybdenum compound B1 was 4.34 g, which was a yield of 61%. In addition, the obtained organic molybdenum compound B1 was subjected to molecular weight measurement and elemental analysis. The obtained organic molybdenum compound B1 had a molecular weight of 534.04 gmol⁻¹. In addition, the results of the elemental analysis are as follows.

Found1: C, 52.56%; H, 5.30%; N, 2.09%; S, 28.12%

Found2: C, 52.82%; H, 5.21%; N, 1.40%; S, 27.59%

Calcd.: C, 40.59%; H, 6.06%; N, 5.26%; S, 24.08%

From these results, it was understood that organic molybdenum compound B1 obtained in Synthesis Example 5 was the compound represented by formula (15) below. The reaction formula in Synthesis Example 5 is shown in formula (16) below.

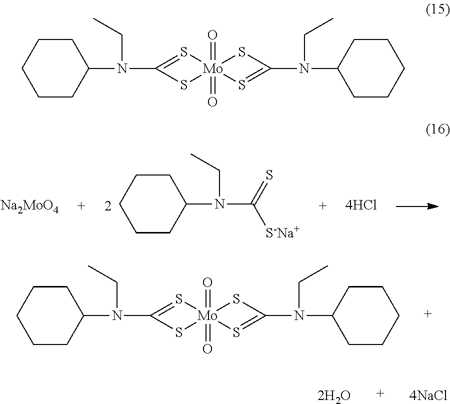

### Synthesis Example 6

### Synthesis of Organic Molybdenum Compound B2

Organic molybdenum compound B2 was synthesized using organic molybdenum compound B1 obtained in Synthesis Example 5. Specifically, organic molybdenum compound B1 (2.00 g), 2.01 g of triphenylphosphine and 30 cm³ of 1,2-dichloroethane (distillation solvent) were first added to a 200 cm³ three-necked flask fitted with a reflux tube. Next, the three-necked flask was heated to reflux for 30 minutes in an argon atmosphere. 4.54 g of propylene sulfide was then added to the three-necked flask, and the resulting mixture was heated to reflux for 3 hours in an argon atmosphere. The 1,2-dichloroethane was then distilled off under reduced pressure, thereby obtaining a dark green solid. The obtained dark green solid was then purified by means of flash column chromatography using dichloromethane and n-hexane (at a ratio of 2:1 by volume), thereby obtaining organic molybdenum compound B2.

The obtained organic molybdenum compound B2 was in the form of a dark purple-black viscous material. In addition, the obtained quantity of organic molybdenum compound B2 was 1.29 g, which was a yield of 56%. In addition, the obtained organic molybdenum compound B2 was subjected to molecular weight measurement and elemental analysis. The obtained organic molybdenum compound B2 had a molecular weight of 610.02 gmol⁻¹. In addition, the results of the elemental analysis are as follows.

Found1: C, 28.97%; H, 5.37%; N, 3.60%; S, 17.06%

Found2: C, 29.36%; H, 4.85%; N, 3.68%; S, 17.13%

Calcd.: C, 39.45%; H, 5.96%; N, 9.60%; S, 31.60%

From these results, it was understood that organic molybdenum compound B2 obtained in Synthesis Example 6 was the compound represented by formula (3) above. The reaction formula in Synthesis Example 6 is shown in formula (17) below. In formula (17) below, the complex “B1′” is a complex which is unstable to oxidation and which was obtained by adding triphenylphosphine and 1,2-dichloroethane (distillation solvent) to organic molybdenum compound B1 and heating to reflux in an argon atmosphere. Propylene sulfide was then added to the complex “B1′” and heated to reflux in an argon atmosphere, thereby obtaining organic molybdenum compound B2.

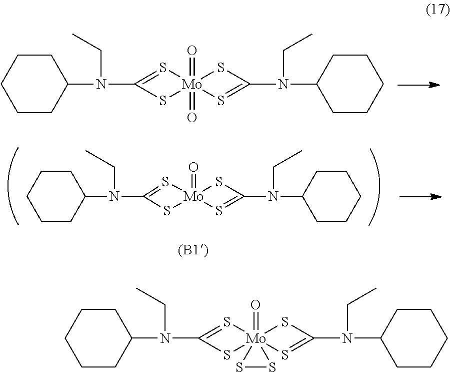

### Preparation of Lubricating Oil Composition of Working Example 2

The lubricating oil composition of Working Example 2 was prepared by adding organic molybdenum compound B2 obtained in Synthesis Example 6 to an ester oil so that the concentration of molybdenum derived from organic molybdenum compound B2 was 500 ppm, and stirring at 80° C. for 1 hour. The ester oil was diisononyl adipate. This ester oil had a kinematic viscosity at 100° C. of 3.04 mm²/s. The obtained lubricating oil composition of Working Example 2 was subjected to a friction test using the same method as that used for the lubricating oil composition of Working Example 1. The measurement results from the friction test are shown in Table 1.

### Working Example 3

An organic molybdenum compound (C1) represented by formula (18) below was obtained by using a secondary amine (N-methyl isobutylamine) as a raw material to prepare the sodium N-methyl isobutylamine dithiocarbamate represented by formula (10) above and then carrying out the reaction pathway represented by formula (19) below.

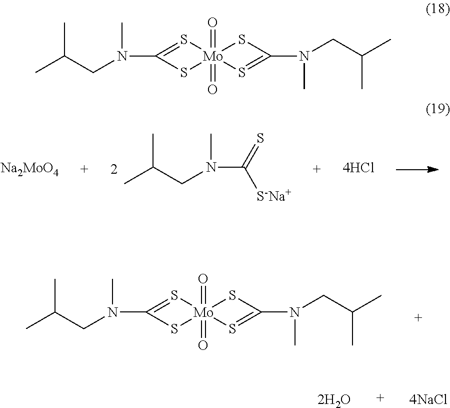

An organic molybdenum compound (C2) represented by formula (4) above was obtained from the obtained organic molybdenum compound (C1) represented by formula (18) above by carrying out the reaction pathway represented by formula (20) below. In formula (20) below, the complex “C1′” is a complex which is unstable to oxidation and which was obtained by adding triphenylphosphine and 1,2-dichloroethane (distillation solvent) to organic molybdenum compound C1 and heating to reflux in an argon atmosphere. Propylene sulfide was then added to the complex “C1′” and heated to reflux in an argon atmosphere, thereby obtaining organic molybdenum compound C2.

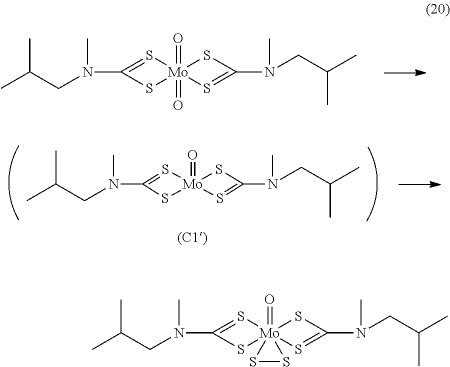

### Preparation of Lubricating Oil Composition of Working Example 3

The lubricating oil composition of Working Example 3 was prepared by adding the thus obtained organic molybdenum compound C2 to an ester oil so that the concentration of molybdenum derived from organic molybdenum compound C2 was 500 ppm, and stirring at 80° C. for 1 hour. The ester oil was diisononyl adipate. This ester oil had a kinematic viscosity at 100° C. of 3.04 mm²/s. The obtained lubricating oil composition of Working Example 3 was subjected to a friction test using the same method as that used for the lubricating oil composition of Working Example 1. The measurement results from the friction test are shown in Table 1.

### Working Example 4

An organic molybdenum compound (D1) represented by formula (21) below was obtained by using a secondary amine (N-methyl butylamine) as a raw material to prepare the sodium N-methyl butylamine dithiocarbamate represented by formula (11) above and then carrying out the reaction pathway represented by formula (22) below.

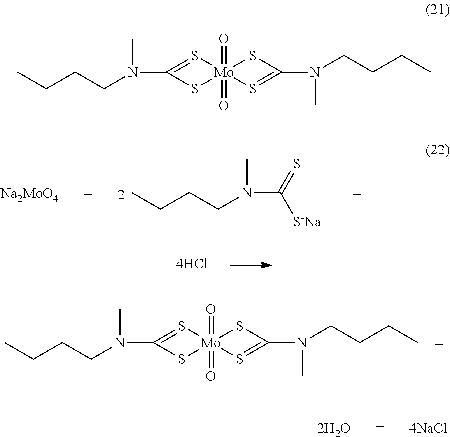

An organic molybdenum compound (D2) represented by formula (5) above was obtained from the obtained organic molybdenum compound (D1) represented by formula (21) above via a complex (D1′) by carrying out the reaction pathway represented by formula (23) below.

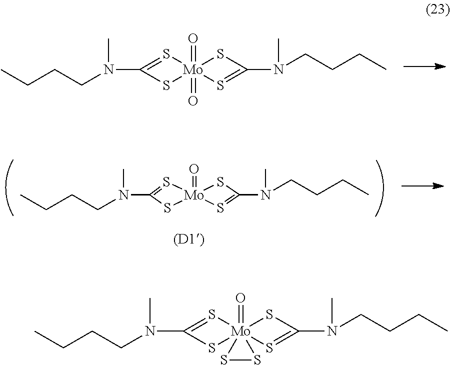

### Preparation of Lubricating Oil Composition of Working Example 4

The lubricating oil composition of Working Example 4 was prepared by adding organic molybdenum compound D2 obtained by means of formula (23) above to an ester oil so that the concentration of molybdenum derived from organic molybdenum compound D2 was 500 ppm, and stirring at 80° C. for 1 hour. The ester oil was diisononyl adipate. This ester oil had a kinematic viscosity at 100° C. of 3.04 mm²/s. The obtained lubricating oil composition of Working Example 4 was subjected to a friction test using the same method as that used for the lubricating oil composition of Working Example 1. The measurement results from the friction test are shown in Table 1.

### Comparative Example 1

An ester oil to which a lubricating oil composition was not added was subjected to a friction test using the same method as that used for the lubricating oil composition of Working Example 1. The measurement results from the friction test are shown in Table 1. The ester oil was diisononyl adipate. This ester oil had a kinematic viscosity at 100° C. of 3.04 mm²/s.

### Working Example 5

The lubricating oil composition of Working Example 5 was prepared by adding organic molybdenum compound A2 obtained in Synthesis Example 3 to a mineral oil so that the concentration of molybdenum derived from organic molybdenum compound A2 was 500 ppm, and stirring at 80° C. for 1 hour. The mineral oil was a mineral oil belonging to group 3 in the base oil categories of the API (American Petroleum Institute). This mineral oil had a kinematic viscosity at 100° C. of 4.23 mm²/s. The lubricating oil composition of Working Example 5 was subjected to a friction test using the same method as that used for the lubricating oil composition of Working Example 1. The measurement results from the friction test are shown in Table 2.

TABLE 2

| | Coefficient of friction | | | | |
|---|---|---|---|---|---|
| | Work- | Work- | Work- | Work- | Compar- |
| Measurement | ing Ex- | ing Ex- | ing Ex- | ing Ex- | ative Ex- |
| period | ample 5 | ample 6 | ample 7 | ample 8 | ample 2 |
| 500 seconds | 0.069 | 0.169 | 0.074 | 0.070 | 0.201 |
| 1000 seconds | 0.068 | 0.177 | 0.074 | 0.079 | 0.196 |
| 1500 seconds | 0.075 | 0.191 | 0.074 | 0.093 | 0.197 |

### Working Example 6

The lubricating oil composition of Working Example 6 was prepared by adding organic molybdenum compound B2 obtained in Synthesis Example 6 to a mineral oil so that the concentration of molybdenum derived from organic molybdenum compound B2 was 500 ppm, and stirring at 80° C. for 1 hour. The mineral oil was a mineral oil belonging to group 3 in the base oil categories of the API (American Petroleum Institute). This mineral oil had a kinematic viscosity at 100° C. of 4.23 mm²/s. The lubricating oil composition of Working Example 6 was subjected to a friction test using the same method as that used for the lubricating oil composition of Working Example 1. The measurement results from the friction test are shown in Table 2.

### Working Example 7

The lubricating oil composition of Working Example 7 was prepared by adding organic molybdenum compound C2 to a mineral oil so that the concentration of molybdenum derived from organic molybdenum compound C2 was 500 ppm, and stirring at 80° C. for 1 hour. The mineral oil was a mineral oil belonging to group 3 in the base oil categories of the API (American Petroleum Institute). This mineral oil had a kinematic viscosity at 100° C. of 4.23 mm²/s. The lubricating oil composition of Working Example 7 was subjected to a friction test using the same method as that used for the lubricating oil composition of Working Example 1. The measurement results from the friction test are shown in Table 2.

### Working Example 8

The lubricating oil composition of Working Example 8 was prepared by adding organic molybdenum compound D2 to a mineral oil so that the concentration of molybdenum derived from organic molybdenum compound D2 was 500 ppm, and stirring at 80° C. for 1 hour. The mineral oil was a mineral oil belonging to group 3 in the base oil categories of the API (American Petroleum Institute). This mineral oil had a kinematic viscosity at 100° C. of 4.23 mm²/s. The lubricating oil composition of Working Example 8 was subjected to a friction test using the same method as that used for the lubricating oil composition of Working Example 1. The measurement results from the friction test are shown in Table 2.

### Comparative Example 2

A mineral oil to which a lubricating oil composition was not added was subjected to a friction test using the same method as that used for the lubricating oil composition of Working Example 1. The measurement results from the friction test are shown in Table 2. The mineral oil was a mineral oil belonging to group 3 in the base oil categories of the API (American Petroleum Institute). This mineral oil had a kinematic viscosity at 100° C. of 4.23 mm²/s.

### INDUSTRIAL APPLICABILITY

The lubricating oil additive of the present invention can be used as a friction modifier that maintains the frictional properties of a lubricant at a suitable level. The lubricating oil composition of the present invention can be advantageously used as a lubricating oil composition used in an internal combustion engine such as an automobile engine.

### EXPLANATION OF THE NUMERALS

1: Lubricating oil composition, 10: SRV reciprocating-type friction tester, 11: Disc, 12: Cylinder.

1. A lubricating oil additive comprising an organic molybdenum compound represented by general formula (1) below: 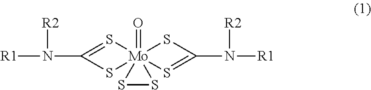
wherein in formula (1), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different.

2. A lubricating oil additive according to claim 1, wherein in the alkyl group represented by the general formula CₙH₂ₙ₊₁ in R1, the number of carbon atoms (n) is an integer from 2 to 20.

3. A lubricating oil additive according to claim 1, wherein in the alkyl group represented by the general formula CₙH₂ₙ₊₁ in R1, the number of carbon atoms (n) is an integer from 3 to 18.

4. A lubricating oil additive according to claim 1, wherein in the alkyl group represented by the general formula CₙH₂ₙ₊₁ in R1, the number of carbon atoms (n) is an integer from 4 to 12.

5. A lubricating oil additive according to claim 1, wherein R1 is a cyclohexyl group and R2 is a methyl group.

6. A lubricating oil additive according to claim 1, wherein R1 is a cyclohexyl group and R2 is an ethyl group.

7. A lubricating oil additive according to claim 1, wherein R1 is an i-butyl group and R2 is a methyl group.

8. A lubricating oil additive according to claim 1, wherein R1 is an n-butyl group and R2 is a methyl group.

9. (canceled)

10. A lubricating oil composition comprising a base oil and a lubricating oil additive comprising an organic molybdenum compound represented by general formula (1) below: 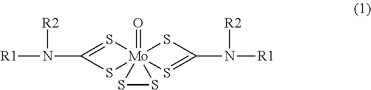
wherein in formula (1), R1 denotes a straight chain or branched chain alkyl group represented by the general formula CₙH₂ₙ₊₁ (n is a positive integer) or a cyclohexyl group, R2 denotes a methyl group or an ethyl group, and R1 and R2 are different.

11. A lubricating oil composition according to claim 10, wherein in the alkyl group represented by the general formula CₙH₂ₙ₊₁ in R1, the number of carbon atoms (n) is an integer from 2 to 20.

12. A lubricating oil composition according to claim 10, wherein in the alkyl group represented by the general formula CₙH₂ₙ₊₁ in R1, the number of carbon atoms (n) is an integer from 3 to 18.

13. A lubricating oil composition according to claim 10, wherein in the alkyl group represented by the general formula CₙH₂ₙ₊₁ in R1, the number of carbon atoms (n) is an integer from 4 to 12.

14. A lubricating oil composition according to claim 10, wherein R1 is a cyclohexyl group and R2 is a methyl group.

15. A lubricating oil composition according to claim 10, wherein R1 is a cyclohexyl group and R2 is an ethyl group.

16. A lubricating oil composition according to claim 10, wherein R1 is an i-butyl group and R2 is a methyl group.

17. A lubricating oil composition according to claim 10, wherein R1 is an n-butyl group and R2 is a methyl group.

18. A lubricating oil composition according to claim 10, wherein the lubricating oil additive is present in the lubricating oil composition in an amount of from 50 to 2000 ppm.
